(19) United States
(12) Patent Application Publication
(10) Pub. No.: US 2021/0052986 A1
(43) Pub. Date: Feb. 25, 2021

(54) FANTASY PLAYER ALGORITHM

(71) Applicant: Fantasy Pot Odds, LLC, South Lyon, MI (US)

(72) Inventor: Andrew D. STICKEL, South Lyon, MI (US)

(21) Appl. No.: 17/007,279

(22) Filed: Aug. 31, 2020

Related U.S. Application Data
(63) Continuation of application No. 15/189,803, filed on Jun. 22, 2016, now abandoned.
Application No. 15/189,803 is a continuation-in-part of application No. 14/211,652, filed on Mar. 14, 2014, now abandoned.
(60) Provisional application No. 61/788,274, filed on Mar. 15, 2013.

(51) Int. Cl. A63F 13/65; A63F 13/46

(52) U.S. Cl. CPC A63F 13/65; A63F 13/46

(57) ABSTRACT

A system and method calculates discounted projected values (DPVs) of players of a fantasy sports league. Weighted average logic receives prior season value based drafting (VBD) values corresponding to athletes of a first position. The weighted average logic calculates weighted VBD values of players of the first position based, at least in part, on the two or more seasons of prior VBD values. A curved line fit logic configured to fit the weighted VBD values to a curved line. A projected value (PV) logic calculates new PVs of players of the first position based, at least in part, on the curved line. Discount PV logic creates discounted PVs (DPVs) of the first position players by subtracting a constant value from each new PV. The DPVs provide a draft selection guide that is an indication of future performance of athletes in the first player position relative to other player position types.

### CROSS-REFERENCE TO RELATED APPLICATIONS

This application claims priority to and the benefit of U.S. patent application Ser. No. 14/211,652, filed Mar. 14, 2014, which claims priority to and the benefit of U.S. Provisional Application No. 61/788,274, filed Mar. 15, 2013, the disclosures of which are incorporated herein in their entirety by reference.

### BACKGROUND

This invention relates in general to fantasy sports, and more particularly to the selection of players for a fantasy team.

### SUMMARY

A plurality of players in one or more sports leagues can be evaluated for selection to a fantasy sports team.

A computer based processing system may include a subsystem with a pre-value module that calculates a fantasy score associated with a sports player based on a performance statistic associated with the sports player and a fantasy league scoring system. In embodiments, various scoring aspects can be based, additionally or independently, upon roster requirements within the fantasy league. The subsystem may also include a value-based drafting module that calculates a value-based score associated with the sports player based on the fantasy score and a reference score, and a projected value module that calculates a projected value based on the value-based score and a ranking associated with the sports player.

A method includes gathering from a fantasy sports league: a fantasy league scoring system, a fantasy league player list including a plurality of players, a plurality of player statistics respectively associated with the plurality of players, a plurality of player ranks associated with the plurality of players, and fantasy league roster constraints. The method may also comprise calculating a plurality of value-based scores respectively for the plurality of players, wherein the value-based score is based on a reference score and the plurality of statistics as applied to the fantasy league scoring system. The method may additionally include determining a plurality of projected values for the plurality of players based on a relationship between the plurality of player ranks and the plurality of value-based scores, and generating a draft strategy based at least on the plurality of value-based scores and the plurality of projected values.

In another embodiment, a computer based processing system includes a subsystem with a fantasy league input module that collects at least a fantasy league scoring system, a fantasy league player list including a plurality of players, a plurality of player statistics respectively associated with the plurality of players, a plurality of player ranks associated with the plurality of players, and fantasy league roster constraints. The system may also comprise a value-based drafting module that calculates a plurality of value-based scores respectively for the plurality of players. The value-based score is based on a reference score and the plurality of statistics as applied to the fantasy league scoring system. In addition, the subsystem may include a projected value module that determines a plurality of projected values for the plurality of players based on a relationship between the plurality of player ranks and the plurality of value-based scores, and a draft reporting module that generates a draft strategy based at least on the plurality of value-based scores and the plurality of projected values.

Various additional aspects will become apparent to those skilled in the art from the following detailed description and the accompanying drawings.

In another embodiment, a system calculates discounted projected values (DPVs) of players of a fantasy sports league. The system includes weighted average logic, curve line fit logic, projected value (PV) logic and discount PV logic. The weighted average logic receives two or more seasons of prior value based drafting (VBD) values associated with athletes of a first player position of a plurality of player position types of the fantasy sports league. The weighted average logic calculates weighted VBD values of players of the first position based, at least in part, on the two or more seasons of prior VBD values. The weight values of at least two of the two or more seasons of prior VBD values are different. The weighted curve line fit logic fits the weighted VBD values to a curved line that may be a logarithmic curved line. The PV logic calculates new PVs of players of the first position based, at least in part, on the curved line. The discount PV logic configured to create discounted PVs (DPVs) of players of the first position by subtracting a constant value from each new PV. The DPVs provide a draft selection guide that is an indication of future performance of athletes in the first player position relative to athletes of the plurality of player position types. In some embodiments, a draft reporting module generates a draft strategy based, at least in part, on the DPVs. The draft reporting module outputs the draft strategy to allow a person drafting a fantasy sports team to draft athletes based, at least in part, on the draft strategy.

In another embodiment, a method calculates DPVs of players of a fantasy sports league. The method begins by receiving two or more seasons of prior VBD values associated with athletes of a first player position of a plurality of player position types of the fantasy sports league. Next weighted VBD values of players of the first position are calculated based, at least in part, on the two or more seasons of prior VBD values. Weight values multiplied to at least two of the two or more seasons of prior VBD values are different. The method then fits the weighted VBD values to a curved logarithmic line. Next, new PVs of draft positions of players to be drafted are calculated based, at least in part, on the curved logarithmic line. The method then creates discounted PVs (DPVs) of players of the first position by subtracting the smallest new PV value from each new PV value to create discounted DBVs.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 is a block diagram of a system for reporting customized fantasy player values according to a scoring system.

FIG. 2 is a block diagram of a system for reporting a preferred draft strategy for selecting a team.

FIG. 3 is a block diagram of a system for selecting a team according to a dynamic draft strategy.

FIG. 4 is a block diagram of a system for selecting a team including roster changes following completion of a draft.

FIG. 5 is a block diagram of a system for selecting a team based on previous team performance.

FIG. 6 is a flowchart of a methodology for reporting customized asset rosters.

FIG. 7 is a flowchart of a methodology for reporting one or more draft strategies for selecting a team.

FIG. 8 is a flowchart of a methodology for selecting a team according to a dynamic draft strategy.

FIG. 9 is an embodiment of an example system that calculates discounted projected values for athletes of a fantasy league.

FIG. 10 illustrates an example of weighted value based draft values fitted to an exemplary natural logarithm curve.

FIG. 11 is an embodiment of an example method that calculates discounted projected values for athletes of a fantasy league.

### DETAILED DESCRIPTION

The following describes a selection of fantasy assets, e.g. players, for groups or fantasy teams. In certain embodiments players available for drafting in a fantasy sports league are analyzed according to the scoring system of the fantasy sports league. This analysis can be used to develop a draft strategy that maximizes a team manager's point scoring in the particular league based on the league's settings. It must be understood that while the following description may refer to a particular draft system, it is to be understood that the draft system may be any fantasy draft system, such as those that are part of a dynasty or keeper league or those that have rules regarding a salary cap or those that may use an auction draft method, just for a few examples.

Generally, as used herein, an asset can be a subject selected, based on its qualities or performance, by an entity that manages the asset or an asset group including the asset. Assets can be of various types, and have uses or functions filling positions that generate value. Asset groups can be assembled to maximize value across a variety of different types, uses, or positions, on different time frames. Time frames can be, for example, portions of a sports season, an entire sports season, multiple sports seasons (or specific portions of multiple sports seasons, e.g., a particular month), and others. Asset groups can be governed by various restrictions or requirements limiting how many assets of particular types or at large can be joined to a group.

For example, in selection of a fantasy sports team, players can be drafted to a manager's fantasy sports team based on the player's performance histories, both with respect to the sport at large and the idiosyncrasies of scoring in one or more fantasy leagues. Rosters of one or more players can be developed for various sports and/or leagues, and teams therein. The rosters can be constrained by league-determined roster requirements that provide for specific positions and a number of players at each position. Based on the performance of the players assigned to a team's roster, the team accumulates points according to a scoring system associated with a fantasy league, and competes with other teams in the fantasy league based on the accumulated score according to particular competitions or time intervals.

As used herein, the term “league” can be used interchangeably to refer to fantasy sports leagues and real-life sports leagues (e.g., the real-world basis for fantasy sports teams). The term “league” can also be used, in particular contexts, to refer to leagues, i.e. sub-portions, within a sport federation or “league”, such as Major League Baseball's American League and National League. Further, baseball is typically associated with major and minor leagues. Where relevant, specific identification of the nature of league will be made to prevent confusion. Nonetheless, discussion of a league will generally be directed toward a fantasy sports league unless otherwise noted.

As discussed above, fantasy sports leagues can include at least one scoring system. The scoring system can convert player performance in real-life competition to fantasy point values credited to the fantasy team possessing the player on its fantasy roster. These point values need not (but can) reflect the value of such activity in the real-life competition. For example, a touchdown may or may not be worth 6 points in a fantasy league, as it is in a real-life National Football League competition. In many fantasy sports leagues, activity that is not credited to the player's real-life team's score is associated with point values in fantasy sports. For example, points are accumulated by real-life baseball teams in runs. While strikeouts can prevent an opposing real-life team from scoring runs, they do not accumulate score and cannot independently win a game for the real life team whose pitcher strikes out batters. However, strikeouts can be credited with a positive point value in fantasy sports, resulting in victory.

Even within a particular fantasy sport, scoring systems are not necessarily fixed from league to league and can be modified or customized by fantasy league participants. For example, one fantasy football league can credit a quarterback 6 fantasy points for a touchdown pass, while another can award ten points. In another example, a first fantasy baseball league can award a point to a team manager who aggregates a larger number of stolen bases in a week, while another league may not even count player or team steals at all. Many types of fantasy leagues can also score on different time bases, such as a rotisserie basis (e.g., season-long point aggregation) or a head-to-head basis (e.g., weekly competition between two fantasy managers). Additional customizations relating to scoring systems can relate to how many teams make the playoffs and on what basis, when the playoffs occur, when a playoff spot is clinched, the use of wildcard playoff spots, matchup seeding, treatment of special events and breaks in the season, and so forth.

Player positions can have several terms associated in both fantasy and real-life sports leagues. Player position can be both a real-life and fantasy roster spot whereby an assigned player engages in the competition to provide effort in a particular location or area of responsibility. A single player may play multiple positions, and a roster can have more than one spot for a single position. Depth can refer to the number of players eligible for a different position. Depth within a league can relate to all or a subset of players who play at a given position. Depth within a team or particular roster can relate to the number of players eligible to be placed in a particular position/roster spot who are on the roster. In particular instances, depth can also refer to the ranking of individuals not presently ranked in the highest/best standings (e.g., a “deep” pick or selection can be the drafting of a player from a poor ranking or other status that does not draw attention).

One position can refer to more than one player. For example, in fantasy football, defense can be regarded as one position and can be drafted in a single turn despite the fact that a team's defense comprises many players. Similarly, while a racing team has one driver, the driver is supported by a team throughout a race. Thus, for purposes herein, position is not limited to a single entity, but refers to situations in fantasy sports where multiple entities are scored in a single category and/or perform together in a manner that benefits singular treatment.

Fantasy sports can refer to “flex,” “utility,” or similar positions. As used herein, such positions can also be called “flexible roster positions.” Such positions are those that are not limited to a single real-life position, or exist outside of standard or full-time positions during an event. For example, in baseball, a utility player can be a hitter who can score offensive points but who does not participate in the defense or have a position on the field when not at bat or on base. Typically, flex, utility or similar positions are roster spots that permit the assignment of players from two or more standard positions as a flexible means of permitting a fantasy team manager to choose a player for the scoring portion of the roster without limiting the manager strictly to a single position. In embodiments, a flex or utility roster spot can be a player assigned to any position (or at least a plurality of positions), or any player otherwise not possessing specific or unique position assignment requirements. For example, a baseball “utility” roster spot can be filled by any player. In another example, a football “flex” roster spot can be filled by a player assigned to any one of several positions (e.g., wide receiver, running back, tight end). In alternative or complementary embodiments, utility or flex positions, or similar variants, can be adapted to more specific or unique requirements.

As alluded above, fantasy sports typically only permit a portion of the roster to score points. As used herein, this is referred to as the scoring or active portion of the roster. The remainder of the roster is the bench, which includes players assigned to the team but not selected to “play” in a given fantasy competition for fantasy score. Real-life teams can also assign a player to the bench if the player is not playing at that time. In addition, many fantasy rosters include spots for a “disabled list,” whereby injured players who are ineligible or unable to play can be retained until healthy without prejudicing the fantasy manager's ability to utilize all spots on his roster to manage players with the potential to score points at any given time. Roster “spots” can exist for a plurality of players. Roster spots can include one or more for scoring/active players who can score fantasy points, and one or more for players on a bench who, while retained by the fantasy team, do not score points until moved from the bench to the active roster. In embodiments, roster spots can exist for players on the disabled list and other player statuses that preclude them from scoring points until removed from the related roster spot. Active/scoring roster spots can reflect real life positions. A fantasy team roster or roster requirements can, but need not, reflect the roster composition, or modifications thereof, of real-life teams.

Participants in a fantasy sports league can have different roles. For example, a commissioner is typically a league administrator who sets up the league (e.g., using a network-based service) and determines the league variables (e.g., scoring system, roster requirements, and others).

As used herein, a “draft strategy” or similar language can be one or more orders and/or rankings for selections in a fantasy sports league draft. Further, draft strategies can utilize more than rankings, but illustrate or explain the second and third order effects of selecting a player. Aspects such as position depth, opportunity cost, and roster constraints (e.g., flex or utility positions, keeper or non-keeper leagues, salary cap leagues, effects of bye-weeks or other down-time, and others) can be calculated and understood to facilitate development of a plurality of quantitative values that assist with a thorough understanding of the likely outcomes of various fantasy league draft decisions. In embodiments, draft strategies can be dynamic, meaning they are updated based on feedback during or after a draft to facilitate continued optimal roster management by the manager of a fantasy sports team.

This is generally directed toward fantasy sports, and more often than not fantasy football as opposed to other sports. In specific embodiments discussing football or another sport, nothing herein should be read to preclude application of aspects disclosed in the context of other sports, different levels of sports (e.g., professional, college), different leagues, and so forth. Various other uses for aspects herein, will be apparent on review of these disclosures.

“Software” or “computer program” as used herein includes, but is not limited to, one or more computer readable and/or executable instructions that cause a computer or other electronic device to perform functions, actions, and/or behave in a desired manner. The instructions can be embodied in various forms such as routines, algorithms, modules or programs including separate applications or code from dynamically linked libraries. Software can also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing element” or “computer device” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to the logic circuitry and/or processing elements and associated software or program involved in managing assets and products associated with a S/R facility. The terms “signal”, “data”, and “information” can be used interchangeably herein and can refer to digital or analog forms. The term “communication device” as used herein can refer to any wired or wireless device (e.g., a computer modem) operable to receive and/or transmit signals, data, or information. The term “virtual” as used herein refers to the simulation of real world objects and characteristics in a computer environment. A “module” can be an aspect executed or effected at least in part by a computer. Collectively, these form a system and any portion or combination thereof may be a subsystem. In the following description the terms “system” and “subsystem” may be used interchangeably.

“Processor” and “Logic”, as used herein, includes but is not limited to hardware, firmware, software and/or combinations of each to perform a function(s) or an action(s), and/or to cause a function or action from another logic, method, and/or system. For example, based on a desired application or need, logic and/or processor may include a software-controlled microprocessor, discrete logic, an application specific integrated circuit (ASIC), a programmed logic device, a memory device containing instructions or the like. Logic and/or processor may include one or more gates, combinations of gates, or other circuit components. Logic and/or a processor may also be fully embodied as software. Where multiple logics and/or processors are described, it may be possible to incorporate the multiple logics and/or processors into one physical logic (or processors). Similarly, where a single logic and/or processor is described, it may be possible to distribute that single logic and/or processor between multiple physical logics and/or processors.

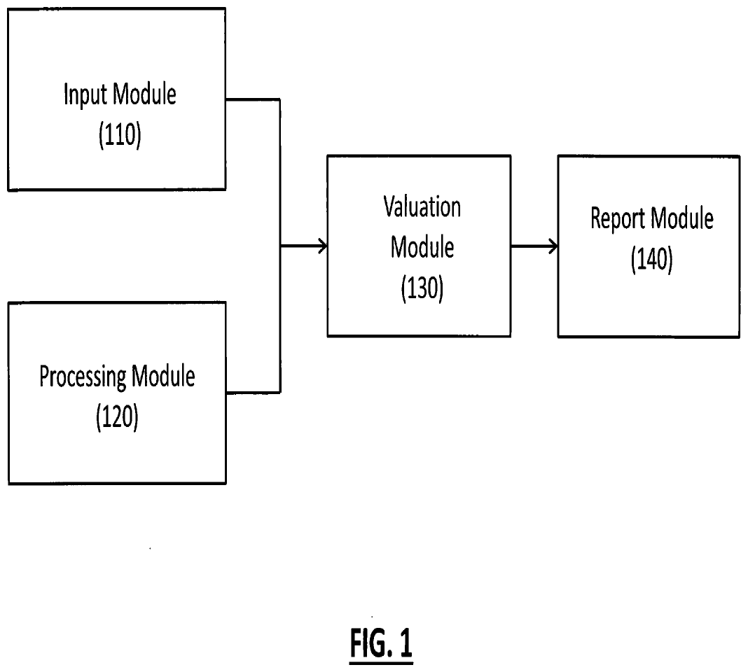

Referring now to the drawings, there is illustrated in FIG. 1 an example block diagram of a system 100 for reporting customized asset values according to a scoring system. System 100 can include input module 110, processing module 120, valuation module 130, and report module 140.

Generally, information received by input module 110 can be provided to processing module 120 for organization, refinement, and development of derived values. Thereafter, valuation module 130 can utilize information gathered by input module 110 and processing module 120 to develop at least one series of scores related to one or more sets of assets identified at least by input module 110. Thereafter, report module 140 can create one or more reports to provide a user or external system for utilization selecting one or more assets.

Input module 110 can receive at least one scoring system, at least one master asset list, and at least one database of information related to the assets. This information can be provided to processing module 120, which calculates information related to the assets based on the database(s) of information both according to the scoring system(s) received and according to other metrics. In embodiments, the other metrics can be related to aspects considered by the scoring system(s). For example, two different scoring systems can weight a value differently, assigning different point values to the same quality or statistic. In alternative or complementary embodiments, other metrics (received by input module 110 or processed by processing module 120) can be unrelated to the scoring system(s).

In embodiments, input module 110 receives customization information from one or more users. For example, a user can have a preference for a particular asset, an asset source or origin, one or more combinations of assets, and others. Customization information provided at least to input module 110 can be used by at least processing module 120 and/or valuation module 130 to weight or increase a value or score, or annotate or otherwise modify a report generated using at least report module 140, in furtherance of customizations included in customization information.

Upon receipt of required information by input module 110 and preparation of aspects of such information by processing module 120, valuation module 130 can use some or all of the available data to value one or more assets from the asset list. In particular, different assets' values (e.g., according to the scoring system(s), according to other metrics, and so forth) can be compared against one another. Such comparisons can be absolute (e.g., difference in one or more scores) and/or in view of one or more asset criteria relating two assets (e.g., difference in one or more scores of analogous assets only).

In particular, system 100 can facilitate the valuation of a plurality of assets in view of one another. One or more constraints applying to the plurality of assets can be identified and used to value a group of assets that is different from the way in which assets would be valued in isolation. For example, different assets can have different uses or roles, and a plurality of roles can be filled by the group. Accordingly, assets can be chosen in a way that maximizes the group's score according to the scoring system(s), as opposed to maximizing any one asset's score exclusively without regard for other complementary assets. In another example, one or more assets can have costs associated, and a maximum group cost can constrain the selection of assets. In alternative or complementary embodiments, a cost constraint can be associated with a particular asset role or other subsets of assets. In still other alternative or complementary embodiments, a subset of assets can be pre-selected or arranged such that a portion of the available resources related to the constraints (e.g., total number, particular role, associated costs) are already consumed by some assets.

In embodiments, one or more constraints can be related to particular time frames. For example, assets can be unavailable during particular periods of time. In another example, assets can become available or expected to change value over a period of time. Valuation module 130 can value assets or groups of assets according to particular time periods, or identify changing values over time. In embodiments, back-up assets can be chosen where unavailability of a preferred asset is anticipated, allowing a user to hedge the risk of a particular asset's unavailability.

In embodiments, a user can seek a single best asset group representative of all scoring systems in which the user participates. For example, a user can wish to have a uniform asset group for use according to or by several different scoring systems. In this regard, scoring systems themselves and/or asset values according to each respective scoring system can be averaged or otherwise statistically analyzed to determine a best (e.g., highest scored value) asset or asset group to utilize under all scoring systems. In embodiments, customization information can identify a preferred scoring system or scoring system ranking, placing higher importance on some scoring systems than others, and the statistical analysis can weight or otherwise increase values under the preferred scoring system(s) or decrease values under scoring system(s) identified as less important.

In embodiments, report module 140 can use the valuation information from valuation module 130, both with regard to individual assets and in view of groups, to generate a valuation and/or selection report. In embodiments, report module 140 produces a displayable report including at least asset values by asset and/or group. The displayable report can be in a variety of formats, and can be designed to functionally and/or aesthetically reflect an asset selection interface. In embodiments, the report can be customized according to customization information from input module 110 or other sources. Report customization can reflect functional aspects (e.g., organization of assets, associated values, and/or other information) or aesthetic aspects (e.g., sizes, fonts, and/or colors used, borders, and others).

As described above, multiple asset groups (e.g., from the same assets, from different assets, from subsets of all possible assets, and so forth) can be valued and/or selected according to multiple scoring systems. For example, an identical or similar group of assets can be scored according to multiple scoring systems, resulting in different valuations and/or selection reports. In embodiments, different scoring systems can be associated with different customization information, facilitating multiple customization options for user preferences according to the particular scoring applied to one or more groups. Report module 140 can generate one report reflecting multiple scoring systems (e.g., different values according to different scoring systems in different columns) or multiple respective reports for each scoring system.

In embodiments, reports can include contingency information. For example if an asset with a high value is found to be unavailable (e.g., assigned to a different group, unable to function effectively, and so forth) alternative assets can be identified according to value. One or more alternative assets identified need not be the next-highest valued asset. For example, based on an asset type or function, an asset group can be made stronger (e.g., higher scores under the scoring system(s)) by identifying a different asset type than would have been chosen for value if the originally identified asset was available.

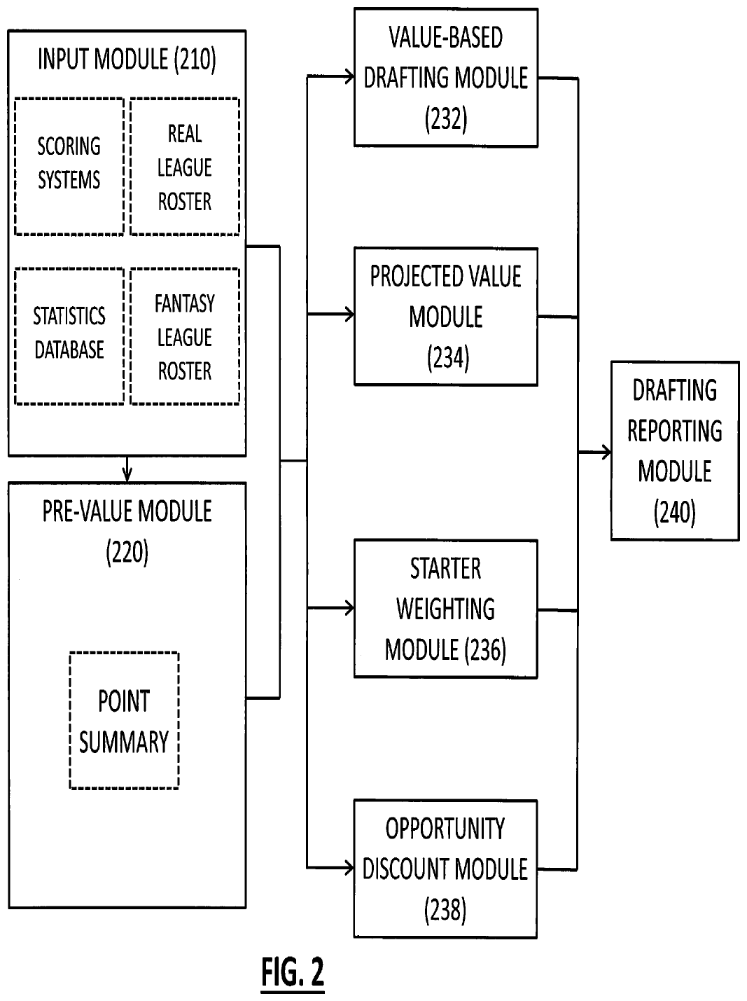

FIG. 2 illustrates an example block diagram of a system 200 for reporting a preferred draft strategy for selecting a team. In particular, the preferred draft strategy can help in development of one or more fantasy sports team rosters of players in one or more leagues using different scoring techniques.

System 200 can include at least input module 210, pre-value module 220, value-based drafting module 232, projected value module 234, starter weighting module 236, opportunity discount module 238, and draft reporting module 240. Input module 210 can gather information related to a sport and its players, fantasy leagues related to the sport, scoring systems associated with the fantasy leagues, and various statistics related to both the real-life sport and the fantasy leagues. This information can be passed to pre-value module 220 which can summarize and process the information for use by other modules. Value-based drafting module 232, projected value module 234, starter weighting module 236, and opportunity discount module 238 resolve valuations directed toward a comprehensive draft strategy according to which players can be selected to the team's best advantage based on the league's particular scoring system. This draft strategy can be included in a report generated by draft reporting module 240.

In particular, input module 210 receives a plurality of information that facilitates valuation of various players and/or teams. Among the information received is the league's scoring system and roster requirements. As suggested above, scoring systems can determine what real-life game actions result in the scoring of fantasy points, and in what amounts fantasy points are added (or subtracted) for real-life game actions. Further, information regarding how points are retained and aggregated (e.g., head-to-head versus rotisserie leagues) can determine which managers advance in league standings by efficiently allocating their draft picks across the available positions in effective depths.

Roster requirements dictate what positions can be drafted by each fantasy team and how many players can be drafted and/or “played” (e.g., in an active, point-accumulating position) per position, as well as a total number of players allowed per fantasy team at a given time. Fantasy teams can be permitted to have a bench, whereby the fantasy teams retains players on its team from which points are not accumulated until they are moved from the bench to an active position. Rosters requirements can be permissive, meaning that no team is required to draft any particular player or position, but failing to draft in accordance with roster requirements can prevent a team manager from accumulating points. If no player exists on the fantasy team to score in non-drafted positions, only a limited number of players drafted can fill the available scoring positions and scoring positions can go empty resulting in no possible points where other team managers are able to accumulate. For example, a fantasy football team can have a roster requirement for one quarterback, meaning a fantasy team manager can “play” (e.g., place on the active roster in a position from which the fantasy team can accumulate points) one or zero quarterbacks. The fantasy team can decline to draft any quarterback, but this can place the fantasy team at a disadvantage as other fantasy teams will score points from quarterbacks placed in the position. Alternatively, the fantasy team can draft five quarterbacks. However, this will place the fantasy team at a disadvantage as only one quarterback's weekly real-life performance will be used in the accumulation of fantasy team points, and the fantasy team will commit a large proportion of its total players per team to quarterbacks who are on the fantasy team's bench, while lacking players or depth in other positions.

Input module 210 can also receive one or more master lists or rosters related to the sport and/or the fantasy league. A roster associated with a sport can include all players within the sport. Embodiments can include or exclude inactive players, injured players, players incoming from or returning to teams outside a professional sports league (e.g., semi-professional, minor league, and others), and so forth. In embodiments, a fantasy league can have a different roster than a real-life league, or can have constraints on the players available from the real-life league. For example, a fantasy league can exclude particular players (e.g., based on league settings, player unavailability, and so forth). In another example, a “keeper league” can permit teams to retain or avoid draft competition with respect to players from previous seasons, removing such players from consideration.

Input module 210 can further receive or access at least one statistics database related to the players on the master lists or rosters. The statistics databases can include real-life statistics from one or more events the players participated in, as well as statistics related to the player's influence on scoring system(s) in one or more fantasy leagues. Statistics can include any statistic regarding performance in a sport associated with the league, as well as various custom statistics derived from other performance metrics. In embodiments, custom statistics identified by a fantasy league commissioner or agreed upon by team managers from a fantasy league can be tracked and utilized in addition to those commonly utilized. Fantasy statistics aggregated can include history from previous seasons within a particular fantasy league or several fantasy leagues. One or more databases received by input module 110 can further include rankings for various periods of time, including pre-season rankings, for given real-life or fantasy leagues according to one or more scoring systems.

Statistics and/or outcomes related thereto need not (but can, in embodiments) mirror the statistics and/or outcomes of real-life sports leagues. For example, a quarterback's real-life franchise can consistently lose games while the quarterback retains a high fantasy point value. In another example, a pitcher can throw such a high number of strikeouts that the excess value becomes irrelevant in a head-to-head league in which strikeout totals far above those accumulated weekly by another team manager carry no relative value.

In embodiments, input module 210 can automatically collect information regarding one or more fantasy leagues and the associated sports by leveraging local or network data. For example, various interfaces can be employed by one or more fantasy leagues or fantasy league providers enabling access to information such as rosters, statistics, real-life teams, scoring systems, other fantasy leagues or teams, and so forth. In an example, an interface or port expressly designed for third-party application access is a feature of a league. In alternative or complementary embodiments, a connected system can download one or more databases related to the league in one or more pre-formatted packages. In still other alternative or complementary embodiments, information related to one or more fantasy leagues and associated sports can be displayed or queried on a web page related to the fantasy league, and information can be harvested (e.g., recognized, copied, and formatted) from the web page for use by system 200. In such embodiments, a participant in a fantasy league can provide credentials to facilitate access to the specific league, and generalized information can be retrieved from publicly accessible network sources. Various embodiments herein can permit the requesting, searching, reception, location, collection, et cetera, of relevant information from a variety of integral (e.g., within the league, provided by a party associated with the league, and so forth) or third party (e.g., not directly affiliated with the league) sources. In a non-limiting embodiment, a public sports web site can be “scraped” for information.

In still other alternative or complementary embodiments, one or more databases can be created by an administrator of system 200 for use with system 200 and application in various fantasy leagues. The databases can be downloaded automatically or on-demand (e.g., on request after subscribing to use system 200, on payment of a database fee, and others) for importing into system 200 via input module 210.

A fantasy league commissioner or participant (e.g., team manager) can have various permissions associated with access to particular fantasy league information. For example, various permissions can be associated with viewing or editing rosters, rankings or pre-rankings, messages between fantasy team managers, and so forth. Input module 210 can have permissions based on an associated fantasy team manager (e.g., using or subscribing to system 200), the associated manager's credentials, a fantasy league and/or its settings, and other aspects. While input module 210 can have permissions identical to one or more parties, embodiments are cognizable under the herein where input module 210 has permissions different from those of one or more team managers or commissioners.

Pre-value module 220 can process one or more statistics, generate derived statistics, and aggregate information related to at least a subset of players in a sport and/or league. In embodiments, information can be sorted, organized (or reorganized), indexed, and otherwise prepared for use by other modules of system 200. In embodiments, pre-value module 220 can determine a player list's (e.g., every player in a sport, a subset of players in a sport) fantasy point scorings according to one or more scoring systems over the course of several years. For example, where pre-value module 220 is facilitating a draft strategy for a particular fantasy football league in the year 2013, every National Football League player's weekly fantasy scores (e.g., according to the particular fantasy football league's scoring system for the draft year) can be calculated for 2012, 2011 and 2010, and preserved in both weekly and annual totals. In embodiments, data can be extrapolated over other years or time periods (e.g., 10-year analysis and others). In embodiments and for other sports, other arrangements (e.g., daily scores, per-event scores, per-period scores with respect to a single event, and so forth) will be appreciated with respect to the function of pre-value module 220.

In embodiments, pre-value module 220 can generate a point summary or other preliminary report related to one or more leagues or players within the league(s). The point summary can be presented to one or more users and/or used in other calculations or reports by system 200. For example, a point summary can include real-life league statistics for different years associated with different players, career statistics for the different players, and other information. A portion of the report can include the player's name, position, and total fantasy points scored according to the relevant scoring system over one or more periods of time.

Value-based drafting module 232 can generate a value-based drafting score for each player evaluated at least by pre-value module 220. The value-based drafting score can be a calculated or adjusted number based on the information calculated by pre-value module 220. In embodiments, value-based drafting module 232 can utilize a fantasy league's roster requirements in generating value-based drafting scores and/or rosters.

A value-based drafting score can be a relative measure of the player's strength or scoring potential, according to the pertinent scoring system(s), as compared to other players. In order to locate a baseline for competitive players to be measured by, one or more reference players can be determined by starting players or starters. A starter can be a player who is scheduled to participate in a majority of available games in advance, and plays in a majority of such games as scheduled. Starters can thus be identified statistically according to players who have performance metrics or statistics associated with a plurality of possible playing opportunities. Other means for starter identification can be described herein. Such starter identification would be relevant in both real-life and fantasy leagues. Starter information can include such aspects. A starter value can include a score, scale, percentage, or other metric indicating a likelihood of a player acting as a starter in future events during a period of time.

In accordance with starter-based analysis, a value-based drafting score for a given player can be the difference (e.g., over any time frame such as entire previous season or a subset of a previous season) between the player's score and another player's score. Continuing with this example, the other player (e.g., reference player) used to calculate the difference can be a starting player who scored the lowest number of fantasy points in the time period. Thus, the value-based drafting score for a particular wide receiver can be the particular wide receiver's fantasy score total over the period less the points scored by the lowest-scoring (on the particular fantasy scoring system) wide receiver during the same period.

In embodiments, value-based drafting module 232 can identify starters according to a technique whereby it is determined that the number of starters in a given position for a fantasy league is equal to the number of teams in the fantasy league multiplied by the number of active/scoring roster spots on each fantasy team in the fantasy league. For example, a twelve team league with one active/scoring quarterback position per team per week can be identified as a league having twelve quarterback starters. In another example, a ten team league with two active/scoring running back positions per team per week can be identified as having twenty running back starters. In an alternative embodiments, starters can be identified by a fantasy score threshold based on the scoring season and statistics from past seasons.

After identifying the number of starters, value-based drafting module 232 can locate the highest-scoring players in the league (or on the roster) for each scoring position. For example, the National Football League can have approximately 150 running backs. A fantasy football league with ten fantasy teams and two starting positions for running backs per team can identify the top 20 fantasy point scorers (according to the relevant scoring system) among the approximately 150 running backs and identify these players as starters during the period of time considered (e.g., season).

In embodiments, value-based drafting module 232 can treat flex positions as adding a starting position for any position permitted in an active/scoring flex spot. In other embodiments, a flex position can count as one-half towards the number starters. In still other embodiments, a flex position can count as some other proportion of a starter based on previous seasons or projected seasons (e.g., proportion of times a particular position did in fact start in the flex position).

In another embodiment, value-based drafting module 232 identifies flex starters according to a flex starter technique. The flex starter technique first removes all players identified as starters in other positions from consideration. The remaining roster (e.g., all players in a sport less players already identified as starters) can have fantasy scores associated with each player on the remaining roster based on the player's performance over a period of time and the fantasy league scoring system. The remaining roster can be ranked from highest to lowest fantasy scores, and search from highest to lowest to identify the highest-ranked players eligible for the flex position. For example, if a fantasy league allows a fantasy team manager to start a wide receiver or a running back in the flex position, the remaining roster would be searched for the highest ranked wide receiver or running back as judged by at least value-based drafting scores according to the scoring system. Thus, in a twelve team fantasy league with one active/scoring flex position per team, the top twelve players who play a position eligible for the flex spot can be identified as flex starters.

Thus, starters can be identified according to at least the techniques outlined to identify “best” or “worst” starters to function as a baseline or reference player in the development of value-based drafting scores by value-based drafting module 232. For example, the lowest-scoring starter in each position and/or lowest-scoring flex starters can be used to identify score amounts to be used in the calculation of value-based drafting scores. In embodiments, the value-based drafting score need not be a difference between the player being scored and the worst starter in the category, but can instead be a ratio, percentage, sum, or other quantity that relates the player being scored against a baseline or reference player. In this regard, a “reference value” can be the score amount associated with a reference player.

In embodiments, value-based drafting module 232 can generate a value-based drafting roster based at least on the value-based drafting scores of a plurality of players. In embodiments, players included on a value-based drafting roster can have a value-based drafting score above a particular threshold. For example, players with a positive value-based drafting score can be included on a value-based drafting roster. In embodiments, the value-based drafting roster can be generated by removing players that do not have an appropriate value-based drafting score from one or more rosters used to generate the value-based drafting scores for the included players.

In embodiments, a value-based drafting roster developed by value-based drafting module 232 can include rookies and/or players with insufficient sports career history to evaluate in accordance with the foregoing. In other embodiments, rookies can be excluded. Various techniques can be used based on the rookie's projected statistics or scoring potential can be used to rank or seed rookies according to aspects herein. In embodiments, performance history predating the current league (e.g., minor league record, college record, international record) can be evaluated. This distance/alternate league history can be compared to other players who have participated in the same or similar leagues. Alternatively, these statistics can be weighted, discounted, or modified for use in projecting sufficient performance history for analysis.

Projected value module 234 can calculate projected values for each player at least according to the relevant scoring system and historical player information. In embodiments, projected value module 234 can identify the top pre-season ranked player(s) for positions identified as roster requirements. If multiple seasons are being considered, the player with the highest average preseason rank (e.g., lowest preseason ranking number, number one is top ranked) over a specified number of seasons can be the highest pre-season ranked player for determination of projected value. In embodiments, average preseason rankings for a given position can be determined to a depth of several players per team. One or more value-based drafting scores (e.g., single season, three season average, five season average, career average, and others) can be identified. Once a relevant set of value-based drafting scores have been identified for a plurality of ranked players (e.g., at least a number required for roster requirements of entire fantasy league), each player's respective rank can be plotted against at least one of their value-based drafting scores (e.g., 3-season average, 5-season average, and others), grouped by position (e.g., in football, quarterback, running back, defense, and others). A representative equation and/or line of best fit can be determined relating each position's top-ranked players to value-based drafting scores. In embodiments, a logarithmic regression can be used. In embodiments, other regressions can be utilized. Using the resulting equation, each evaluated player's value-based drafting score can be projected for the coming season based at least in part on their pre-season ranking.

In embodiments, information associated with a plurality of seasons used in calculation of projected value can be weighted to prefer more recent information to that from earlier seasons. For example, a weighting factor of 40% can be utilized for a last season, a weighting factor of 35% can be used for information from two seasons ago, and a weighting factor of 25% can be used for information from three seasons ago. Other possible weighting arrangements, using more or fewer seasons and different weighting factors, will be appreciated in view of the disclosures herein. For the purposes of this application, a “recent season” or “recent statistic” can be a season or statistic that is relatively near chronologically in view of the set of seasons or statistics under consideration (e.g., if last season if 2 or 3 seasons considered, last two seasons if 5 or 7 seasons considered, and so forth). A “distant season” or “distant statistic” can be a season or statistic that is comparatively old chronologically in view of the set of statistics under consideration.

In other embodiments, players can be ranked according to their value-based drafting scores, which are used in place of preseason rankings to identify players for whom representative equations are developed. In alternative or complementary embodiments, the player's average draft pick number can be used in lieu of a pre-season ranking. A player's average draft pick number can be their “pick number” (e.g., the number of other players picked before the player plus one) during previous draft(s) (e.g., first player picked in entire draft is number one, first player picked by the third team manager drafting is number 3, second player picked by first team manager drafting in second round of draft is number 11, and so forth).

In embodiments, projected value module 234 can project a value of a pre-season rank, rather than a player. For example, to determine the accuracy and or relevance of pre-season ranking, or to project at least one other value based on the player's rank, valuation can be performed on information related to a plurality of players at a given pre-season rank over a plurality of seasons. In various embodiments of this and other aspects of system 200, a coefficient of determination or R-squared value can be utilized to broaden appreciation for such models.

Starter weighting module 236 can determine the likelihood regarding whether a given player will be a starter on a fantasy sports team in one or more leagues, meaning the player will be played in an active roster spot during one or more fantasy scoring periods and/or complete the current or upcoming season with a value-based drafting score greater than or equal to zero. Such aspects can be employed to evaluate, for example, a team's depth. Starter weighting module 236 can facilitate modifying the player's fit in a fantasy drafting strategy based on the likelihood that the player will start. A player's starting percentage can be averaged over a period of time. In an embodiment, a player's starting percentage can be the number of times the player started (or played a threshold amount of an event) divided by the number of opportunities the player could have started (e.g., number of starts in a fantasy league versus maximum number of possible starts, number of starts in a fantasy league versus number of possible starts while-owned, and others). In embodiments, a determination of whether a player was a starter can result in a binary valuation, whereby players who are determined to be starters receive a value of 1 or 100% for a given year, and players who are determined not to be starters receive a 0 or 0% for the given year. In embodiments, several years can be averaged to determine starting percentage.

After determining a starting percentage, pre-season rank can be plotted against starting percentage grouped by position. A representative equation and/or line of best fit can be determined relating each position's top-ranked players to their starting percentage. In embodiments, a linear regression can be used. In embodiments, other regressions can be utilized. Using the resulting equation, each evaluated player's starting percentage can be projected for the coming season based at least in part on their pre-season ranking. In embodiments, the projected starting percentage for a player can be presented as an individual metric for consideration in isolation. In other embodiments, the projected starting percentage for a player can be used to weight (e.g., start percentage 50%, multiply value to be weighted by 0.50) various other metrics or values described herein or used in the sports' respective statistics.

In embodiments, starter weighting module 236 can weight a pre-season rank, rather than a player. For example, to determine the accuracy and or relevance of pre-season ranking, or to project at least one other value based on the player's rank, weighting can be performed on information related to a plurality of players at a given pre-season rank over a plurality of seasons.

Opportunity discount module 238 can evaluate a player to potentially be drafted in view of alternative players. In embodiments, opportunity discount module 238 can calculate (or modify) a player's rank, value, or other metrics in a draft strategy based on the availability of alternative players. For example, a player's projected value can be reduced by the projected value of the next-best player available in the same position. In specific embodiments, a logic associated with at least opportunity discount module 238 can select the lowest-scoring starter according to value-based drafting scores. In this fashion, a calibrated projected value can be generated.

The calibrated projected value can be based on, for example, the number of times a position is drafted in one or more fantasy leagues. In embodiments, the total number of players drafted in one or more fantasy leagues can also be used.

In embodiments, opportunity discount module 238 can evaluate a pre-season rank, rather than a player. For example, to determine the accuracy and or relevance of pre-season ranking, discounting can be performed on information related to a plurality of players at a given pre-season rank over a plurality of seasons.

In embodiments, opportunity discount module 238 can multiply a position factor by the number of players drafted for league to assist in determining an opportunity discount. The position factor can be, for example, the percentage of players in a sport in the particular position. In embodiments, the position factor can be an arbitrary value selected by an administrator associated with system 200. In alternative or complementary embodiments, the position factor can be based at least in part on historical drafts (e.g., within the fantasy league, within a plurality of fantasy leagues, according to a plurality of pre-draft rankings, and others).

In embodiments, a calibrated projected value calculated by opportunity discount module 238 can be measured in terms of players' projected values as determined by projected value module 234. For example, the calibrated projected value of a player can be based, at least in part, on the difference between the projected value of the player's projected value as determined by projected value module 234 and the projected value of the last-drafted player for the same position. In this example, if a quarter back being evaluated has a projected value of 70, and the last quarterback drafted (e.g., during the initial draft) in the previous season has a projected value of 3 this season, the quarterback being evaluated can have a calibrated projected value of 67. In embodiments, the projected value of the last-picked player for a given position can be averaged over several last-picked players from several recent years, or averaged over a plurality of seasons.

In alternative embodiments, the calibrated projected value can reference other respective picks. For example, the player picked half-way through a respective position's drafting can serve as a reference projected value to subtract in calculating a projected value. It will be appreciated in view of the disclosures herein that a variety of such selections can illustrate the marginal benefit of one player compared to another in a variety of ways for a given position.

Draft reporting module 240 can report information from system 200. In embodiments, draft reporting module 240 generates a report including one or more of a spreadsheet, text document, image, and/or proprietary display (e.g., on a device, in an application, and others) that provides a draft strategy specifically tailored to the relevant scoring system and roster requirements. The report can include league information, information about the scoring system, player names and positions, one or more ranks (e.g., previous season, pre-season, projected, and others), average draft pick, starting percentage and information (e.g., historical and/or projected, bye-weeks, and others), value-based drafting score, projected value, calibrated projected value, graphs and/or plots of projected value and/or starting percentage based on rank, and other aspects. In embodiments, calculations for a plurality of previous years can also be included in the report. The report can include a variety of different pages, workbooks, tabs, et cetera to facilitate easy browsing of specific statistics relating to particular leagues, seasons, and positions. In embodiments, a plurality of different fantasy leagues employing different scoring systems can be included in the same report.

In embodiments, the report generated by draft reporting module 240 can include one or more ranking systems to indicate a preferred draft order or arrangement in accordance with the draft strategy. A draft-position ranking can rank players according to positions, and, in embodiments, can indicate which positions can be drafted first in accordance with the draft strategy. A draft-overall ranking can rank all players at large against one another based on one or more metrics, statistics, and/or values.

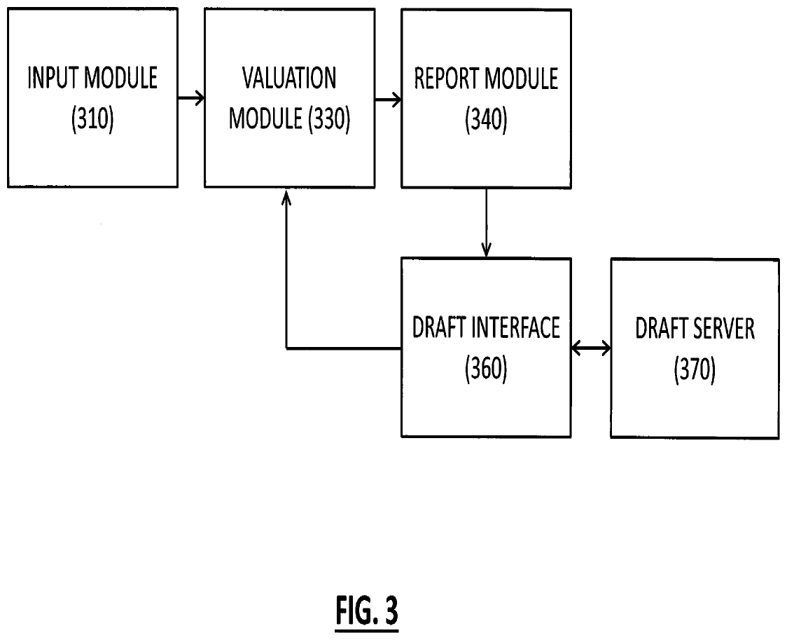

Turning now to FIG. 3, illustrated is an example block diagram of a system 300 for selecting a team according to a dynamic draft strategy. System 300 can include input module 310 for collecting input related to a sport and a fantasy league based on a sport, valuation module 330 for determining values related to players and/or teams of the sport to develop a draft strategy, report module 340 to report the draft strategy, draft interface 360 to interact with software facilitating a league draft (e.g., connection to website or network application), and draft server 370.

Input module 310 and valuation module 330 can function to determine a draft strategy as described herein based at least in part on a scoring system of a fantasy league and information related to a sport and its players. Draft interface 360 facilitates communication with draft server 370 at least during an online draft. Draft interface 360 can monitor the activity of a draft (e.g., team manager turns picking players to draft, what players are drafted, and others) and return this information as feedback to valuation module 330.

Using live information from the draft received via draft interface 360, valuation module 330 can update a draft strategy in view of a current draft status. For example, if several players whose projected values heavily influenced a draft strategy are drafted by other fantasy team managers, the draft strategy can be rendered ineffective. Thus, valuation module 330 can continuously recalculate player values, position selections, and draft strategy in view of the players actually available in an ongoing draft, rather than the players considered prior to commencement of the draft. In embodiments, valuation module 330 can determine the collective projected values (or projected fantasy points) associated with partially-drafted teams of other fantasy team managers. Once the values or scores of a rival team are calculated, valuation module 330 can seek to exploit selections or positions that can result in higher projected fantasy score differentials for a particular position or team.

In an alternative embodiment a pre-calculated contingency technique can be used with system 300 as opposed to recalculating the draft strategy after one or more draft turns. Under a contingency model, one or more likely draft outcomes can be determined, and several draft strategies can be developed based on possible draft picks by a plurality of competing team managers. Based on the players drafted, system 300 can toggle between a plurality of predetermined strategies to most closely mirror the in-draft conditions and prioritize draft selections accordingly.

In embodiments, report module 340 can be configured to interact with draft interface 360 and automatically conduct a draft in accordance with a draft strategy developed at least using valuation module 330. For example, various spreadsheets, macros, scripts, programs, et cetera can be employed to forward the priorities of a draft strategy to draft server 370 for processing and/or execution.

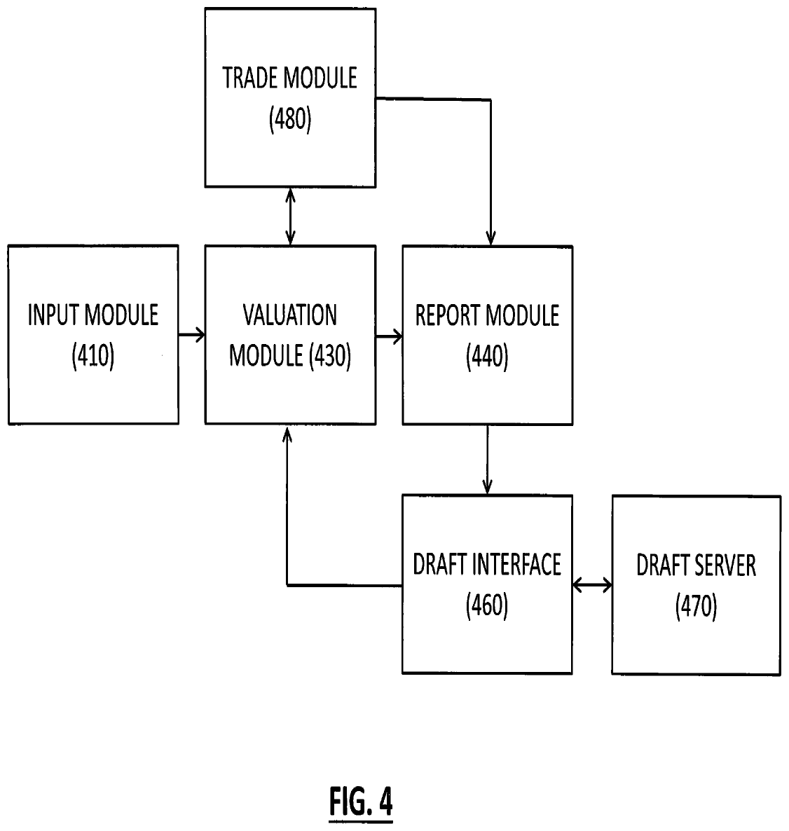

FIG. 4 illustrates an example block diagram of a system 400 for selecting a team including roster changes following completion of a draft. System 400 can include input module 410 for collecting input related to a sport and a fantasy league based on the sport, valuation module 430 for determining values related to players and/or teams of the sport to develop a draft strategy, report module 440 to report the draft strategy, draft interface 460 to interact with software facilitating a league draft (e.g., connection to website or network application), and draft server 470. In addition, system 400 can include at least trade module 480.

Input module 410 and valuation module 430 can function to determine a draft strategy as described herein based at least in part on a scoring system of a fantasy league and information related to a sport and its players. Draft interface 460 facilitates communication with draft server 470 at least during an online draft. Draft interface 460 can monitor the activity of a draft (e.g., team manager turns picking players to draft, what players are drafted, and others) and return this information as feedback to at least valuation module 430 and trade module 480. In embodiments, ongoing feedback during a season can also be returned to at least valuation module 430 and trade module 480.

Using live information from the draft received via draft interface 460, valuation module 430 can update a draft strategy in view of a current draft status. If it is determined that a player drafted by another team can have a substantial influence on a manager's team (or removal of this player from the other team would otherwise improve the manger's odds of victory), trade module 480 can notify the manager of a suggested trade. In an embodiment, the suggested trade notification can occur in real-time during a draft. In another embodiment, a plurality of summed projected values and/or projected fantasy points for the league's teams as-drafted can be calculated, and trades can be suggested based on moves within the league that would have the largest influence on a fantasy team manager's projected values or fantasy points while reducing those of his competitors.

In embodiments, a manager can desire to propose a trade, and system 400 can re-evaluate at least a portion of a fantasy league in which the manager participates both before and after the trade. In this way, the impact of the trade can be fully appreciated in terms of historical and projected information. Similarly, trades proposed to the manager can be evaluated, and counter-offers can be determined and assessed using at least techniques herein. For example, the differences in projected value (e.g., as of start of season, for remainder of season, and others), or updated mid-season projected values (including pending or passed periods of unavailability and/or modified starter weighting) can be utilized to improve the confidence of a manager engaged in trading players between teams.

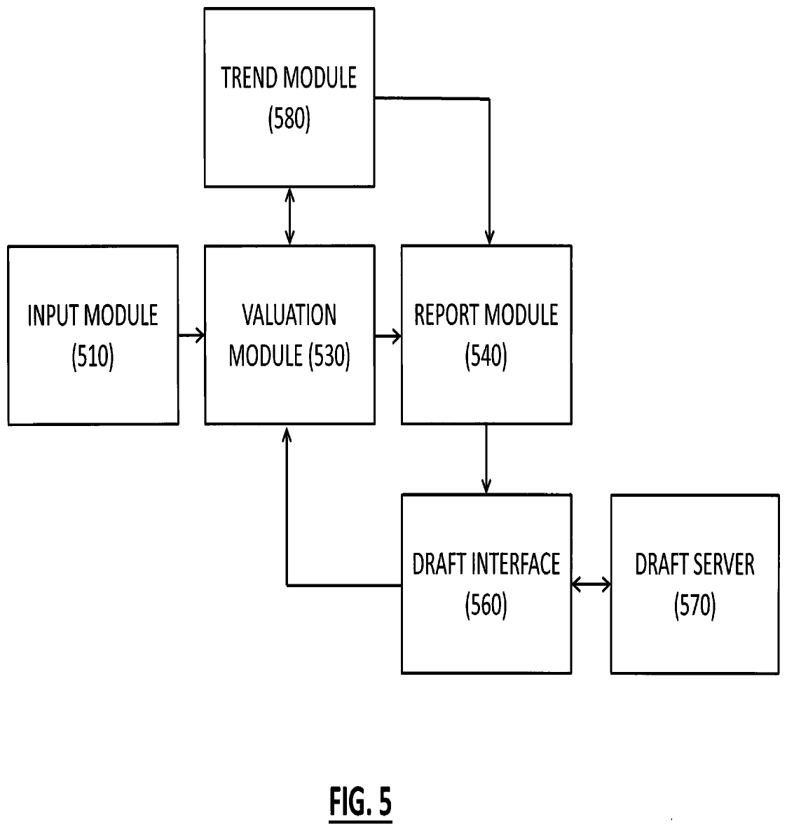

FIG. 5 illustrates an example block diagram of a system 500 for selecting a team based on previous team performance. System 500 can include input module 510 for collecting input related to a sport and a fantasy league based on a sport, valuation module 530 for determining values related to players and/or teams of the sport to develop a draft strategy, report module 540 to report the draft strategy, draft interface 560 to interact with software facilitating a league draft (e.g., connection to website or network application), and draft server 570. In addition, system 500 can include at least trend module 580.

A team manager can draft a team and proceed to manage that team over the season. The draft can be based, at least in part, on previous fantasy team performance in past seasons. As the current season progresses, draft server 570 can be queried (or automatically return) information about changes to a fantasy team roster and performance. In addition to updating the strategy using advantages or optimizations identified by valuation module 530, trend module 580 can identify trends occurring that can cost the team manager fantasy points. For example, the team manager can repeatedly, over the course of several seasons, drop or trade tight ends in an attempt to acquire better running backs. However, this can cause the manager to bench a substantial amount of the fantasy team's strength (as, in this example, running backs are left on the bench), and can yield marginal benefits less than if alternative changes were pursued or if no changes at all were committed. In a similar example, a team manager can make frequent changes to a roster (e.g., benching players with a higher calibrated projected value in favor of an incorrect instinct to play an alternative) within 24 hours of games that cause a net negative result in terms of fantasy points. Such trends can be identified by trend module 580, and the fantasy team manager can be notified (e.g., using report module 540, or in a separate notification from trend module 580) to avoid repeating mistakes throughout a season or over a plurality of seasons.

Example methods may be better appreciated with reference to flow diagrams. For purposes of simplicity, explanation of the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not-illustrated blocks.

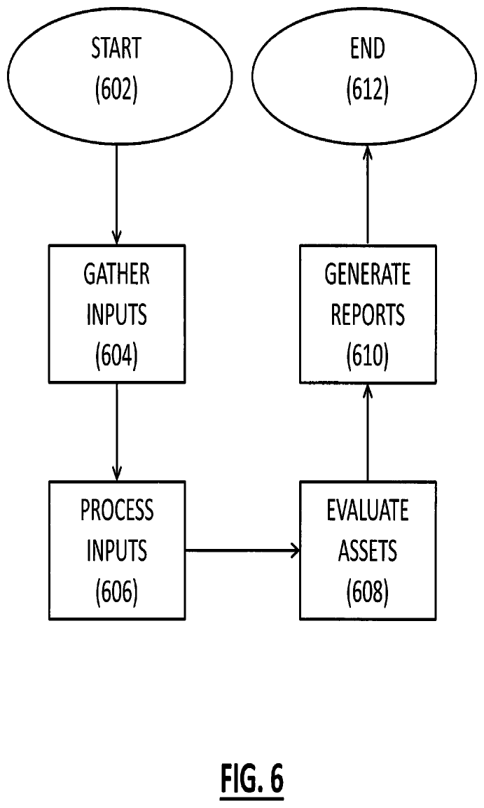

Turning now to FIG. 6, illustrated is an example flowchart of a methodology 600 for reporting customized asset rosters. Methodology 600 starts at 602 and proceeds to gather inputs at 604. Inputs can include, but are not limited to, information about one or more scoring systems used to score assets, one or more asset groups and/or rosters, information about requirements related to asset groups and/or rosters, statistics related to the assets, information about asset performance, and others.

At 606, the inputs gathered at 604 can be processed. Processing can include, but is not limited to, application of asset statistics to the one or more scoring systems. Processing can further include compiling, organizing, sorting, indexing, and otherwise preparing gathered inputs for use in calculation. In embodiments, processing at 606 includes generating a summary of information gathered and initial calculations relating to the information.

At 608, a plurality of assets can be evaluated according to at least quantities identified during the gather of inputs at 604. Evaluation of the assets at 608 can include, but is not limited to, the projection of statistics or performance in the future based on information gathered and processed. Evaluation can include the development of a plurality of relative metrics showing the performance of one or more assets in relation to at least one reference asset. Further, regression equations representing historical performance can be developed and used in assessing future performance. In embodiments, evaluation can include ranking according to one or more categories, groups, or rosters.

At 610, a report can be generated reflecting the evaluation. The report generated at 610 can include at least relative metrics and projected statistics facilitating comparison of at least a subset of assets under consideration. An optimized asset roster can be assembled based at least in part upon the report generated at 610. The report can be displayed or otherwise provided to one or more entities associated with the asset roster to be developed. Thereafter, methodology 600 can end at 612.

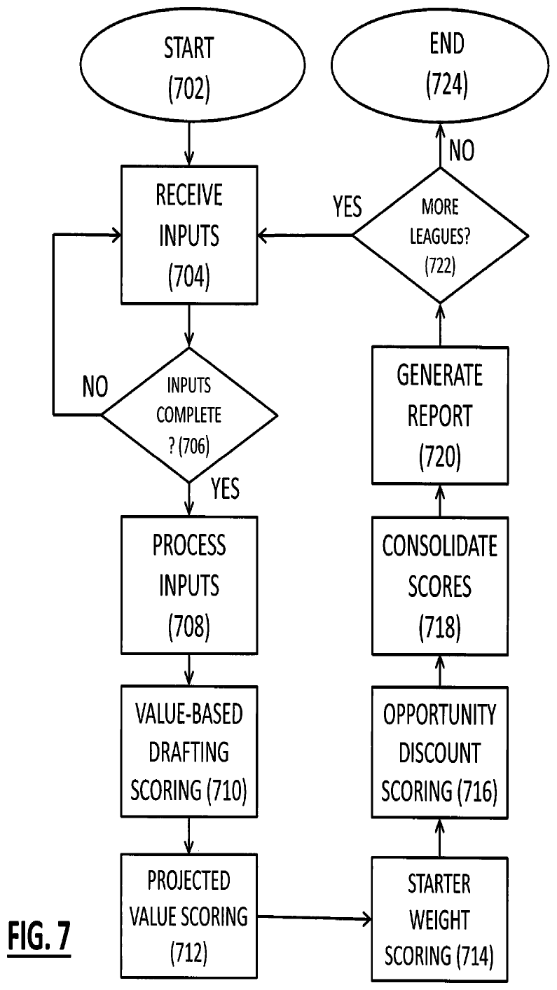

FIG. 7 illustrates an example flowchart of a methodology 700 for reporting one or more preferred draft strategies for selecting a team. Methodology 700 starts at 702 and proceeds to receive inputs at 704. Reception of inputs can be automatic (e.g., collected from the league using the internet and/or one or more interfaces), manual (e.g., user provides at least some interaction to indicate information included in inputs), and combinations thereof. Inputs can include at least information about a fantasy sports league, including the fantasy sports league's scoring system. Inputs received can further include one or more rosters or player lists related to players eligible for drafting in the fantasy sports league, as well as historical, statistical, or projected information related to the players on the rosters or lists. Additional information can include details about the roster requirements for the fantasy teams and/or league, fantasy teams within the fantasy league, fantasy team managers, and so forth. In embodiments, inputs can include user (e.g., at least one fantasy team manager) preferences that change the function of methodology 700 (e.g., include a preferred player in a draft strategy regardless of scoring). At 706, a determination is made whether inputs are complete. If not all required inputs have been received at 706, methodology 700 can recycle to continue receiving inputs at 704. If at least inputs identified as critical to the development of a preferred draft strategy are received, methodology 700 can proceed to 708.

At 708, the inputs are processed. Processing inputs can include (but is not limited to) consolidating, organizing, calculating, and others. For example, a master data file can be created at 708 that contains at least statistics for all of the players of a sport (e.g., their scoring, performance, and other measured activity during competition or training) for periods of time in a given position, as well as information about a fantasy league associated with the sport including roster requirements and scoring systems. The fantasy scores associated with each player according to the fantasy league scoring system can be calculated for the periods of time based on the statistics. In embodiments, a summary sheet can be generated at 708 that shows the inputs and processed values. After the relevant information is processed, methodology 700 can proceed to 710.

At 710, a value-based drafting score can be calculated based on the inputs and/or processed values. In order to create a value-based drafting score, starters for particular positions can be identified based on one or more of real-life player history, fantasy sports player history, fantasy league team number, and other aspects. Once starters are identified, a player's value-based drafting score can be calculated by subtracting a reference starter's fantasy points from the player's fantasy points for a particular period of time. In embodiments, the reference starter can be the lowest-scoring starter (e.g., starter in the fantasy league, starter in real-life league, and others) on the fantasy scoring system. In other embodiments, the reference starter (or points to be subtracted) can be a different, arbitrary amount. For example, embodiments can utilize the middle-scoring starter on the fantasy scoring system, or an average of points from several starters on the fantasy scoring system.

Value-based drafting scores determined at 708 can be calculated for players to be used in flex or utility positions. If a league does not utilize flex or utility positions, this aspect can be excluded or skipped at 708. However, for leagues including roster spots for flex or utility players, a modified or filtered roster can include players not currently in starter positions for non-flex/non-utility roster spots. The modified or filtered roster can include various thresholds for modification and filtering, to allow for over-inclusion such that the lower-scoring portion of potential starters are not lost. In an alternative embodiment, the modified or filtered roster can have thresholds tailored to be under-inclusive and remove all possible starters from consideration for flex positions. The modified or filtered roster can be searched for the highest scoring players (according to the fantasy scoring system) for one or more previous periods, and the highest scoring players can be evaluated to determine if they are eligible for the flex or utility position. The highest scoring players eligible for the flex positions are then identified at least until a number of possible flex players greater than or equal to the number of flex positions in the fantasy league based on the number of teams and roster requirements is identified.

At 712, a projected value of each identified starter, flex player, and/or other player can be identified. The projected value can be calculated based at least in part on an equation that defines a line of best fit for a plot of value-based drafting scores against player rankings in their respective position or at large in the league. For example, pre-season player rankings can be plotted against the value-based drafting score, and a regression representing the relationship between ranking and score can be determined. The resulting equation can be used to determine a player in a given position's projected value by providing their pre-season ranking to at least the equation for a current/next season projected value. In embodiments, values used in calculations to determine projected value based on multiple seasons can be weighted to ascribe a higher weight or importance to more recent seasons while reducing the impact of more distant seasons on the calculations. In embodiments, the equation can be a logarithmic regression.

At 714, players in the sport and/or league can be evaluated based on their likelihood of being a starter. For one or more previous seasons, each player's starting percentage and/or starter designation can be valued (e.g., as a binary 1 or 0, according to a percentage of possible competitions in which they started, according to a proportion of competition periods played, and others). In embodiments, a percentage starter value can be determined and/or estimated using projected information for current or future seasons (e.g., in order to include players with limited history in calculations). The player's starting percentage can be plotted against their ranking (e.g., pre-season ranking) for one or more years, and an equation defining a line of best fit through the plotted points can be calculated. Using the equation, one or more players' current season ranking can be used to predict their starting percentage in a current year. In embodiments, the equation can be a linear regression.

At 716, players in the sport and/or league can be evaluated based on a calibrated projected value that discounts one or more evaluations of the player based at least in part on the evaluations of an alternative player who can be drafted alternatively to the player being evaluated for a calibrated projected value. In embodiments, scaling values (e.g., percentages) can be applied, and can be based at least in part on a number of players drafted, a number of players in the same position drafted, and/or the number of players in the sport and/or league. In alternative embodiments, the scaling values can be arbitrary or otherwise provided by an entity associated with methodology 700. In embodiments, the calibrated projected value can be based at least in part on the difference between the player's projected value and the projected value of the player previously drafted having the lowest projected value.

At 718, scores can be consolidated and formatted for storage and/or presentation. For example, the calculated scores can be applied to a data file, table, or spreadsheet that stores the scores for use in a draft strategy. At 720, a report can be generated detailing at least the drafting strategy. The draft strategy and/or report can detail a suggested order to draft players during a fantasy league draft. The suggested order can include, for example, what players to draft first, what positions to draft first, what players to draft in positions, and so forth. The suggested order is formulated to maximize the likelihood of defeating other teams in the fantasy league by maximizing fantasy scores under the league's scoring system (and/or minimizing opponent opportunities to accumulate scores). In embodiments, the report can include multiple draft strategies, or can select a single draft strategy for publication to a user where multiple draft strategies are calculated. Such generation and/or selection of and between multiple draft strategies can be based on, for example, user preferences, statistical information based on sport or fantasy league history, and the actions or drafting behavior of competing league managers.

In embodiments, at least one of the scores consolidated at 718 or the report generated at 720 can be used to auto-draft on behalf of one or more players. For example, the drafting strategy and/or priorities can be forwarded to a web page or to a server through an interface to draft in accordance with the strategy without further input from a team manager in a fantasy league.

At 722, a determination can be made as to whether more leagues exist to determine additional draft strategies. If the player is involved in multiple leagues, a further check can be performed to determine whether additional leagues utilize different scoring systems, roster requirements, available players, or other variables that can cause changes to a draft strategy. If more leagues requiring different strategy calculations exist, methodology 700 recycles to 704 where inputs related to at least one of the additional leagues can be gathered. If all leagues are identical in terms of rosters and scoring systems, or if no additional leagues exist, methodology 700 can proceed to end at 724.

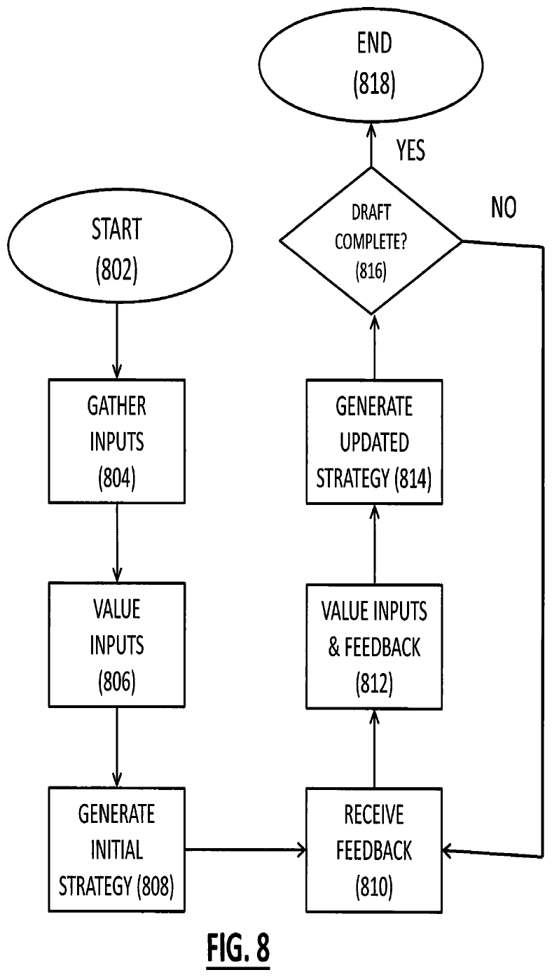

FIG. 8 illustrates an example flowchart of a methodology 800 for selecting a team according to a dynamic draft strategy. Methodology 800 starts at 802 and proceeds to gather inputs at 804. The inputs can relate to at least a fantasy league, a scoring system used by the fantasy league, roster requirements for the fantasy league, players available for drafting in the fantasy league, and statistics and rankings associated with the players. Various other information related to the sport, fantasy team managers, and so forth can also be gathered.

At 806, the players can be valued according to quantities identified during the gather of inputs at 804. For example, valuations can include or relate to the player's rankings at one or more points before or during a sports season, the player's real-life performance in the sport, the player's performance in the fantasy sport according to the scoring system, relative quantities comparing players to other players or scoring benchmarks, and others.

After valuation a report with an initial draft strategy can be produced at 808. The initial draft strategy can suggest an order in which to draft players and positions, and otherwise manage aspects of the draft. The draft strategy can be tailored according to the scoring system of the fantasy league, roster requirements, and other details of the league. The draft strategy can provide the fantasy team manager for who it is prepared with one or more draft orders or suggestions to maximize their points scored under the fantasy league scoring system, and/or minimize their opponents opportunities to score.

A draft can begin and at 810 feedback from the draft can be received. On receipt of feedback (e.g., list of players drafted by particular teams), methodology 800 can repeat one or more aspects previously performed (e.g., with respect to valuation, and particularly valuations performed relative to other players available for drafting in the league) to update or modify the draft strategy in accordance with the actual situation of the league. For example, as players who are preferred in a draft strategy are drafting, second and third order effects related to maximizing fantasy points in particular time frames can suggest that a fantasy team manager draft a position or player different from who would have been drafted in accordance with the original draft strategy. Thus, various values used to determine the draft strategy can change in the fantasy league during the draft. On such changes, the draft strategy can be updated mid-draft to provide an optimal result.

In view of the status of the draft, such re-valuations can occur at 812. New values or draft strategies can be generated based at least in part on a player selected by another team in the draft. At 814, an updated report can be generated or the existing report modified to reflect the feedback and re-valuation.

At 816, a determination can be made regarding whether the draft is complete. If the draft is not complete, methodology 800 recycles to 810 and continues receiving feedback. The re-valuations and generation of reports can repeat at 812 and 814, respectively, until the determination at 816 returns information indicating the draft has ended. Thereafter, methodology 800 can end at 818.

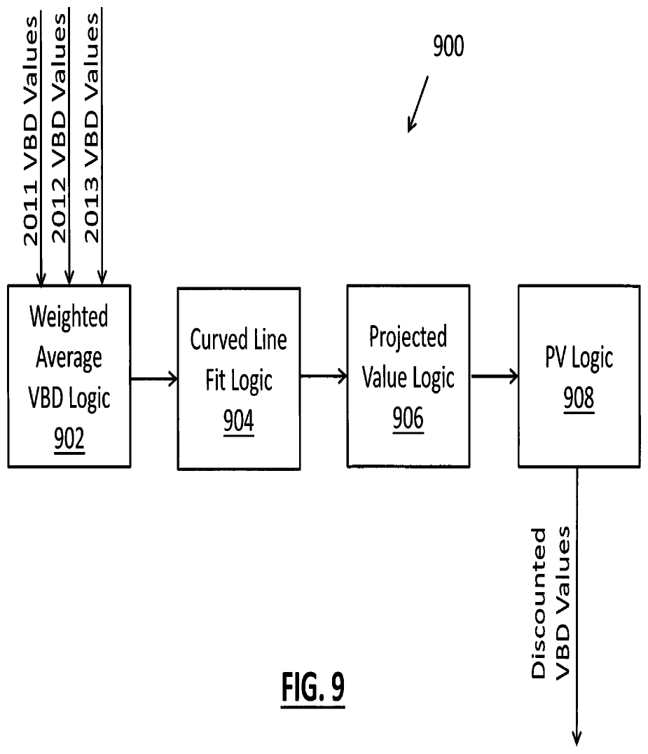

FIG. 9 illustrates an embodiment of a system 900 with various logics used to calculate discounted projected values (PVs) of fantasy sports players. System 900 includes a weighted average VBD logic 902, a curved line fit logic 904, a projected value logic 906 and a discount logic 908. As discussed above, the system 900 may have any one or more of a variety of league rules and any scoring system for individual players and defenses input to the system 900 to establish parameter for the system 900. In one example, the system 900 may receive inputs for the years 2012, 2013 and 2014 that represent prior calculated value based draft (VBD) scores for every skill player in an exemplary football league. These exemplary VBD scores are presented for starting quarterbacks for each of these three years in Table 1:

TABLE 1

| Name | Year | Rank | VBD | Name | Year | Rank | VBD | Name | Year | Rank | VBD |
|---|---|---|---|---|---|---|---|---|---|---|---|
| A. Rodgers-GB | 2012 | 1 | 198 | A. Rodgers-GB | 2013 | 1 | 0 | P. Manning | 2014 | 1 | 192 |
| T. Brady-NE | 2012 | 2 | 203 | D. Brees-NO | 2013 | 2 | 257 | D. Brees-NO | 2014 | 2 | 190 |
| D. Brees-NO | 2012 | 3 | 221 | C. Newton-CAR | 2013 | 3 | 162 | A. Rodgers-GB | 2014 | 3 | 218 |
| M. Stafford-DET | 2012 | 4 | 146 | P. Manning | 2013 | 4 | 318 | M. Stafford-DET | 2014 | 4 | 115 |
| C. Newton-CAR | 2012 | 5 | 169 | T. Brady-NE | 2013 | 5 | 129 | A. Luck-IND | 2014 | 5 | 228 |
| M. Vick-PHI | 2012 | 6 | 0 | M. Ryan-ATL | 2013 | 6 | 139 | T. Brady-NE | 2014 | 6 | 144 |
| E. Manning-NYG | 2012 | 7 | 74 | C. Kaepernick | 2013 | 7 | 107 | C. Newton-CAR | 2014 | 7 | 95 |
| P. Manning-DEN | 2012 | 8 | 177 | M. Stafford | 2013 | 8 | 157 | N. Foles-PHI | 2014 | 8 | 0 |
| T. Romo-DAL | 2012 | 9 | 157 | R. Griffin-WAS | 2013 | 9 | 67 | R. Griffin-WAS | 2014 | 9 | 0 |
| P. Rivers-SD | 2012 | 10 | 50 | A. Luck-IND | 2013 | 10 | 156 | M. Ryan-ATL | 2014 | 10 | 160 |
| M. Ryan-ATL | 2012 | 11 | 170 | R. Wilson-SEA | 2013 | 11 | 122 | C. Kaepernick | 2014 | 11 | 102 |
| B. Roeh-PIT | 2012 | 12 | 52 | T. Romo-DAL | 2013 | 12 | 124 | T. Romo-DAL | 2014 | 12 | 116 |
| R. Griffin-WAS | 2012 | 13 | 154 | E. Manning | 2013 | 13 | 27 | R. Wilson-SEA | 2014 | 13 | 181 |
| M. Schaub-HOU | 2012 | 14 | 72 | A. Dalton-CIN | 2013 | 14 | 164 | J. Cutler-CHI | 2014 | 14 | 121 |
| J. Cutler-CHI | 2012 | 15 | 0 | B. Roeth-PIT | 2013 | 15 | 134 | P. Rivers-SD | 2014 | 15 | 134 |
| J. Freeman-TB | 2012 | 16 | 86 | J. Cutler-CHI | 2013 | 16 | 0 | B. Roeth-PIT | 2014 | 16 | 190 |
| A. Smith-SF | 2012 | 17 | 0 | M. Vick-PHI | 2013 | 17 | 0 | A. Dalton-CIN | 2014 | 17 | 74 |
| A. Dalton-CIN | 2012 | 18 | 89 | J. Flacco-BAL | 2013 | 18 | 76 | A. Smith-KC | 2014 | 18 | 64 |
| J. Flacco-BAL | 2012 | 19 | 77 | S. Bradford | 2013 | 19 | 0 | E. Manning | 2014 | 19 | 141 |
| A. Luck-IND | 2012 | 20 | 131 | J. Freeman-TB | 2013 | 20 | 0 | C. Palmer-ARI | 2014 | 20 | 0 |
| C. Palmer-OAK | 2012 | 21 | 67 | R. Tannehill | 2013 | 21 | 103 | J. Flacco-BAL | 2014 | 21 | 123 |
| T. Tebow-NYJ | 2012 | 22 | 0 | C. Palmer-ARI | 2013 | 22 | 92 | J. Manziel-CLE | 2014 | 22 | 0 |
| S. Bradford-STL | 2012 | 23 | 70 | M. Schaub | 2013 | 23 | 0 | R. Tannehill-MIA | 2014 | 23 | 150 |
| R. Fitzpatrick-BUF | 2012 | 24 | 44 | P. Rivers-SD | 2013 | 24 | 163 | M. Vick-NYJ | 2014 | 24 | 0 |
| M. Flynn-SEA | 2012 | 25 | 0 | A. Smith-KC | 2013 | 25 | 109 | J. McCown-TB | 2014 | 25 | 0 |
| M. Sanchez-NYJ | 2012 | 26 | 0 | E. Manuel-BUF | 2013 | 26 | 0 | J. Parker-FA | 2014 | 26 | |
| M. Cassel-KC | 2012 | 27 | 0 | J. Locker-TEN | 2013 | 27 | 0 | E. Manuel-BUF | 2014 | 27 | 0 |
| B. Weeden-CLE | 2012 | 28 | 0 | B. Weeden | 2013 | 28 | 0 | T. Bridgewa | 2014 | 28 | 14 |
| K. Kolb-ARI | 2012 | 29 | 0 | G. Smith | 2013 | 29 | 33 | J. locker | 2014 | 29 | 0 |

In one example embodiment, the DBV scores (e.g., DBV values) may be calculated first by calculating fantasy points per game for every player (quarterbacks in this example) for every game for each of the last 3 years. The fantasy rule of points per season may be the actual points a quarter back has scored or may be a number derived from that according to a fantasy league “scoring system”. Even though quarterbacks (QB) are illustrated in tables 1-3, the process of calculating discounted PVs is the same for each type of skill position or for defenses. In one embodiment the DBVs for each year (2012-14) of Table 1 are calculated by first determining the number of starters for each team and the number of players started at each position. Table 1 illustrates that there is one quarterback starting on each of 29 football teams. The DBVs of Table 1 are then determined by subtracting the point total of lowest scoring quarterback from every other quarterback. All negative values are changed to 0. Again, this would also be done for the starting running backs, receivers, and so on. As illustrated in FIG. 9, these values for the years 2012-14 are input to the weighted average VBD logic 902.

Based on these three years of VBD scores for each starting quarterback, the weighted average VBD logic 902 calculates weighted VBD scores for each quarterback position to be drafted in the current fantasy year. Exemplary weighted VBD scores based on the three previous years of VBD scores are illustrated in Table 2:

TABLE 2
Weighted VBD

126.3
216.7
199.2
193.8
178.6
106.3
94.0
99.2
62.7
131.1
126.0
102.8
120.4
123.8
100.5
97.5
29.6
74.5
75.7
32.8
102.0
32.2
77.5
68.1
38.2
0.0
0.0
5.6
11.6

Again while three prior years are used to calculate the scores in Table 2, any suitable number of prior year VBD scores may be used. In example Table 2, the weighted average for the first QB to be drafted is calculated as follows:

Weighted VBD=(2014VBD*0.40)+(2013VBD)*0.35+(2012VBD)*0.25

Weighted VBD=192*0.40+0*0.35+198*0.25

Weighted VBD=126.3

The Weighted VBDs for the remaining starting QBs (QB #2 through QB #29) to be drafted are calculated in a similar way. The values of 40%, 35% and 25% are the weighted values given to the prior year 2012, 2013 and 2014 VBDs, respectively. Of course, in other embodiments different percentages may be used for other desired weightings of different years. Preferably, these weighting percentages sum to 100%.

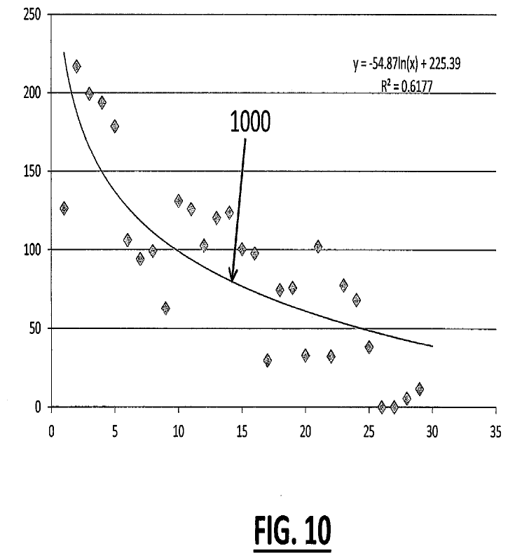

Using the weighted VBD results the novel curved line fit logic 920 fits these results to a curved line. Unlike prior art systems, using a curved line fit rather than a linear line fit later produces better weighted PV values. The curved line fit logic 920 may fit the weighted VBD results to any curved line including exponential and/or logarithmic lines/curves. In some embodiments the VBD results may be fitted to two or more different curved line segments. Exemplary FIG. 10 illustrates the weighted VBD values of Table 2 fitted to a curved fit line 1000 (FIG. 10) that is a natural logarithmic (1n) line:

Y=−54.87*ln+225.4

The resulting curved fit line 1000 produced by the curved line fit logic 920 is then used by the projected value (PV) logic 930 to generate the PVs for starting QBs 1 through 29 as illustrated in Table 3:

TABLE 3

| | QB PV | QB DPV |
|---|---|---|
| 1 | 225.4 | 205.1 |
| 2 | 187.4 | 167.1 |
| 3 | 165.1 | 144.8 |
| 4 | 149.3 | 129.0 |
| 5 | 137.1 | 116.8 |
| 6 | 127.1 | 106.8 |
| 7 | 118.6 | 98.3 |
| 8 | 111.3 | 91.0 |
| 9 | 104.8 | 84.5 |
| 10 | 99.0 | 78.7 |
| 11 | 93.8 | 73.5 |
| 12 | 89.0 | 68.7 |
| 13 | 84.7 | 64.3 |
| 14 | 80.6 | 60.3 |
| 15 | 76.8 | 56.5 |
| 16 | 73.3 | 53.0 |
| 17 | 69.9 | 49.6 |
| 18 | 66.8 | 46.5 |
| 19 | 63.8 | 43.5 |
| 20 | 61.0 | 40.7 |
| 21 | 58.3 | 38.0 |
| 22 | 55.8 | 35.5 |
| 23 | 53.3 | 33.0 |
| 24 | 51.0 | 30.7 |
| 25 | 48.8 | 28.5 |
| 26 | 46.6 | 26.3 |
| 27 | 44.5 | 24.2 |
| 28 | 42.6 | 22.2 |
| 29 | 40.6 | 20.3 |
| 30 | 38.8 | 18.5 |
| 31 | 37.0 | 16.7 |
| 32 | 35.2 | 14.9 |
| 33 | 33.5 | 13.2 |
| 34 | 31.9 | 11.6 |
| 35 | 30.3 | 10.0 |
| 36 | 28.8 | 8.5 |
| 37 | 27.3 | 7.0 |
| 38 | 25.8 | 5.5 |
| 39 | 24.4 | 4.1 |
| 40 | 23.0 | 2.7 |
| 41 | 21.6 | 1.3 |
| 42 | 20.3 | 0 |

Notice that this exemplary fantasy league has a draft that allows for up to 42 quarterbacks to be drafted. Therefore, Table 3 has 42 QB new PV entries generated from the curved fit line 1000 of FIG. 10.

The QB PV entries are input to the discount logic 908 that applies a discount to each of the 42 QB entries. In this exemplary embodiment, the PV (20.3) of the last QB drafted (QB #42) is subtracted from each QB entry. For example, subtracting 20.3 from the PV of QB #1 (225.4-20.3) results in a discounted PV (DPV) of 205.1 and so on for the rest of the QB positions to be drafted.

As previously mentioned, discounted PVs (DPVs) of other skill positions, defenses and the like are calculated similar to how the DPVs of the quarterbacks are determined. The DPV of all positions of the fantasy league may then be combined into a single listing or set of data. The DPVs allow for a manager of a fantasy team to determine remaining draft players with the highest potential value (DPV) regardless of position. This allows the manager of the fantasy team to select players remaining in a draft that have the highest DPV.

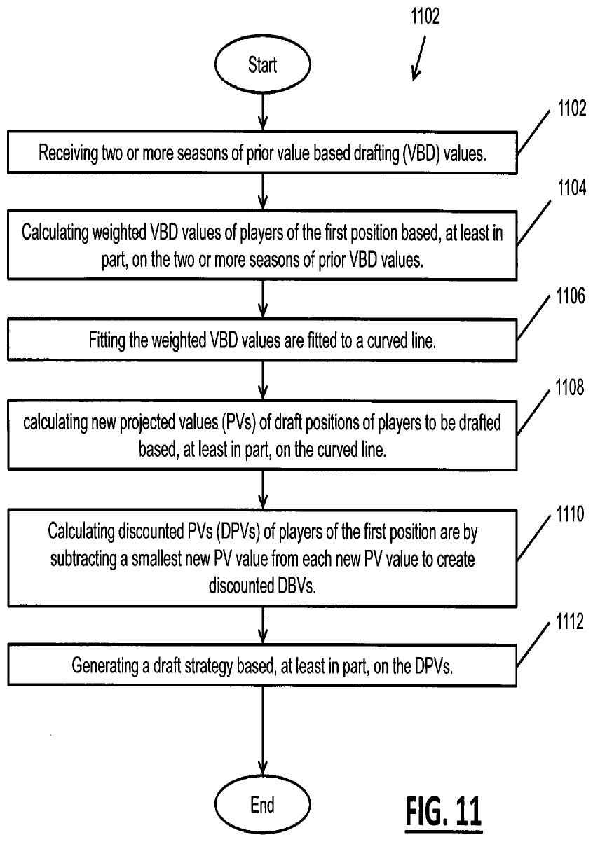

FIG. 11 illustrates an example method 1100 of calculating discounted projected values (PVs) of players of a fantasy sports league. The method 1100 begins by receiving two or more seasons of prior value based drafting (VBD) values, at 1102. These values are associated with athletes of a first player position of a plurality of player position types of the fantasy sports league. At 1104, the method 1100 calculates weighted VBD values of players of the first position based, at least in part, on the two or more seasons of prior VBD values. The weight values are multiplied respectively to at least two of the two or more seasons of prior VBD values are different. The weighted VBD values are fitted, at 1106, to a curved line that may be a logarithmic line. The method 1100 calculates new projected values (PVs) of draft positions of players to be drafted, at 1108, based, at least in part, on the curved line. Discounted PVs (DPVs) of players of the first position are calculated, at 1110, by subtracting a smallest new PV value from each new PV value to create discounted DBVs. A draft strategy is generated, at 1112, based, at least in part, on the DPVs. The draft strategy is output to allow a person drafting a fantasy sports team to draft athletes based, at least in part, on the draft strategy.

In one embodiment, the average draft position (ADP) as understood by those with ordinary skill in the art may be used to assign actual players to each of the DBVs. These assignments may also be made based on preseason rankings and/or ADPs. In other embodiments, one or more experts rankings may be used to match/assign players to the DBV values.

While principles and modes of operation have been explained and illustrated with regard to particular embodiments, it must be understood, however, that this can be practiced otherwise than as specifically explained and illustrated without departing from its spirit or scope.

What is claimed is:

1. A system to calculate discounted projected values (PVs) of players of a fantasy sports league comprising:
weighted average logic configured to receive two or more seasons of prior value based drafting (VBD) values associated with athletes of a first player position of a plurality of player position types of the fantasy sports league, wherein the weighted average logic is configured to calculate weighted VBD values of players of the first position based, at least in part, on the two or more seasons of prior VBD values, and wherein weight values of at least two of the two or more seasons of prior VBD values are different;
curved line fit logic configured to fit the weighted VBD values to a curved line;
projected value (PV) logic configured to calculate new PVs of players of the first position based, at least in part, on the curved line; and
discount PV logic configured to create discounted PVs (DPVs) of players of the first position by subtracting a constant value from each new PV, wherein the DPVs provide a draft selection guide that is an indication of future performance of the athletes in the first player position relative to athletes of the plurality of player position types.

2. The system to calculate discounted PVs of players of the fantasy sports league further comprising:
a draft reporting module configured to generate a draft strategy based, at least in part, on the DPV, wherein the draft reporting module is configured to output the draft strategy to allow a person drafting a fantasy sports team to draft sports athletes based, at least in part, on the draft strategy.

3. The system to calculate discounted PVs of players of the fantasy sports league of claim 1 wherein the prior VBD values are based, at least in part, on points scored by the athletes of the first player position.

4. The system to calculate discounted PVs of players of the fantasy sports league of claim 1 wherein the curved line is a logarithmic line.

5. The system to calculate discounted PVs of players of the fantasy sports league of claim 1 wherein the curved line is based on a nature logarithmic (ln) line.

6. The system to calculate discounted PVs of players of the fantasy sports league of claim 1 wherein the curved line is based on a curved exponential function.

7. The system to calculate discounted PVs of players of the fantasy sports league of claim 6 wherein the curved line is expressed by:
new PV=−A*ln(X)+B,
where X is a position number of a quarterback to be drafted, and wherein A and B are constants.

8. The system to calculate discounted PVs of players of the fantasy sports league of claim 7 wherein B is the highest new PV value.

9. The system to calculate discounted PVs of players of the fantasy sports league of claim 1 wherein the curved line fit logic is configured to fit the weighted VBD values to two or more curved line segments that form a single curved line.

10. The system to calculate discounted PVs of players of the fantasy sports league of claim 1 wherein the discount logic is configured to subtracted the new DPV of the last player of the first position to be drafted from each of the new PVs to create the discounted PV (DPV).

11. The system to calculate discounted PVs of players of the fantasy sports league of claim 1 wherein the weighted average logic only calculates weighted VBD values of players of the first position that are starters.

12. The system to calculate discounted PVs of players of the fantasy sports league of claim 1 wherein the PV logic is configured to calculate new PVs of non-starting players of the first position that are to be drafted based, at least in part, on the curved line.

13. The system to calculate discounted PVs of players of the fantasy sports league of claim 1 wherein the weighted average logic calculates the weighted VBD values based, at least in part on VBD values of three prior seasons.

14. The system to calculate discounted PVs of players of the fantasy sports league of claim 13 wherein each of the three seasons has a different weight value.

15. The system to calculate discounted PVs of players of the fantasy sports league of claim 14 wherein the three seasons comprise a first season, a second season and a third season, wherein the first season has a weight value of 25 percent, the second season has a weight value of 35 percent and the third season has a weight value of 40 percent.

16. The system to calculate discounted PVs of players of the fantasy sports league of claim 15 further comprising wherein the weight values sum up to 100 percent.

17. The system to calculate discounted PVs of players of the fantasy sports league of claim 1 further comprising wherein the first player position is football quarterback.

18. A system comprising:
weighted average logic configured to receive two or more seasons of prior value based drafting (VBD) values associated with athletes of a first player position of a plurality of player position types of a fantasy sports league, wherein the weighted average logic is configured to calculate weighted VBD values of players of the first position based, at least in part, on the two or more seasons of prior VBD values, and wherein weight values associated with at least two of the two or more seasons of prior VBD values are different;
curved line fit logic configured to fit the weighted VBD values to a curved logarithmic line;
projected value (PV) logic configured to calculate new PV values of draft positions of players to be drafted based, at least in part, on the curved line; and
discount PV logic configured to create discounted PVs (DPVs) of players of the first position by subtracting a smallest new PV value from each new PV value to create the discounted DBVs, wherein the DPVs provide a draft selection guide that is an indication of future performance of the athletes in the first player position relative to all athletes of the plurality of players; and
a draft reporting module configured to generate a draft strategy based, at least in part, on the DPVs, wherein the draft reporting module is configured to output the draft strategy to allow a person drafting a fantasy sports team to draft future athletes based, at least in part, on the draft strategy.

19. A method comprising:
receiving two or more seasons of prior value based drafting (VBD) values associated with athletes of a first player position of a plurality of player position types of the fantasy sports league;
calculate weighted VBD values of players of the first position based, at least in part, on the two or more seasons of prior VBD values, and wherein the weight values multiplied respectively to at least two of the two or more seasons of prior VBD values are different;
fitting the weighted VBD values to a curved logarithmic line;
calculating new projected values (PVs) of draft positions of players to be drafted based, at least in part, on the curved logarithmic line; and
creating discounted PVs (DPVs) of players of the first position by subtracting a smallest new PV value from each new PV value to create discounted DBVs; and
generating a draft strategy based, at least in part, on the DPVs. The draft strategy is output to allow a person drafting a fantasy sports team to draft future athletes based, at least in part, on the draft strategy.

20. The method of claim 19 wherein the first player position is football quarterback and further comprising:
calculate DPVs for each of the other plurality of player other positions in the same way as the DPVs for the first player position were calculated.
